(19) United States
(12) Patent Application Publication
(10) Pub. No.: US 2009/0018757 A1
(43) Pub. Date: Jan. 15, 2009

(54) Control device for vehicle

(75) Inventors: Kiyoshi Kobayashi, Toyota-shi (JP); Masato Kaigawa, Toyota-shi (JP); Hidenori Saitoh, Nagoya-shi (JP); Masakazu Owatari, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/216,615

(22) Filed: Jul. 8, 2008

(30) Foreign Application Priority Data
Jul. 12, 2007 (JP) 2007-183448

(51) Int. Cl. G06F 19/00

(52) U.S. Cl. 701/112

(57) ABSTRACT

The present invention relates to a control device for a vehicle, having an engine 10 connected to an automatic transmission 14 via a torque converter 12 incorporating a lockup clutch 32. A fuel cutoff control is performed for interrupting the supply of fuel to the engine 10 when controlling the lockup clutch 32 during a deceleration of the vehicle. The control device is operative to interrupt the fuel cutoff control when a brake pressure P_{BK} of a foot brake 38 for braking the vehicle exceeds a predetermined value. Accordingly, using the brake pressure P_{BK} with increases response as a determining standard enables a sudden deceleration of the vehicle to be appropriately determined in a practical mode, appropriately enabling the suppression of engine stall while realizing improved fuel consumption.

### TECHNICAL FIELD

This invention relates to a control device for a vehicle for performing a fuel cutoff control of an engine when performing a lockup control during a deceleration of the vehicle. More particularly, it relates to improvement for appropriately determining a sudden deceleration of the vehicle during the fuel cutoff operation.

### BACKGROUND ART

There has been known a control device for a vehicle propelled by an engine connected to a transmission via a fluid type power transfer device incorporating therein a lockup clutch. The control device performs a fuel cutoff control for interrupting the supply of fuel to the engine when controllably engaging (controlling slipping-engagement of) the lockup clutch during a deceleration of the vehicle. With such a technology, temporarily interrupting the supply of fuel to the engine realizes the improvement in fuel consumption. Meanwhile, an adverse affect arises with the occurrence of engine stall if the supply of fuel remains interrupted even under a condition where a rotation speed of the engine is caused to decrease due to relatively sudden deceleration of the vehicle.

To address such an issue, an attempt has been made to provide a technology of determining the occurrence of sudden deceleration of the vehicle as the basis for making the determination to interrupt the fuel cutoff control of the engine when performing the lockup control during such a deceleration. The vehicular sudden deceleration detecting device related to such a technology is disclosed in, for instance, Patent Publication 1 (Japanese Patent Application Publication 2004-116563). With such a technology, a comparison is made between an elapse time starting from a preceding pulse signal being input to a current time measured with an elapse time counter, and a pulse period corresponding to a given deceleration relevant to a vehicle speed stored in a vehicle speed storing section. This is regarded to be effective in determining a sudden deceleration on a vehicle speed at the current time without waiting until the vehicle speed is affirmed upon receipt of a subsequent pulse signal being input.

However, with such a technology of the related art wherein the deceleration is determined based on the pulse signal, there may occur the sudden deceleration erroneously determined because of fluctuation in pulse resulting from an input from a road surface due to an increase in sensitivity of such a determination. Further, if the sensitivity of such a determination is lowered for avoiding the occurrence of such an erroneous determination, then, a need arises to raise a lockup lower-limit-value vehicle speed with a view to precluding the occurrence of engine stall. Thus, an adverse affect is encountered with no adequate effect of obtaining improved fuel consumption resulting from the fuel cutoff control.

With such a view in mind, research and development work has been done to provide a vehicular control device that can appropriately determine the occurrence of sudden deceleration of a vehicle with a view to providing improved fuel consumption through a fuel cutoff control executed upon performing a lockup control during deceleration of the vehicle.

### SUMMARY OF THE INVENTION

This present invention has been completed with such a view in mind and has an object to provide a vehicular control device that can appropriately determine the occurrence of sudden deceleration of a vehicle with a view to providing improved fuel consumption through a fuel cutoff control executed upon performing a lockup control during deceleration of the vehicle.

For achieving the above object, the present invention relates to a control device for a vehicle having an engine connected to a transmission via a fluid type power transfer device having a lockup clutch, wherein the control device (i) performs a fuel cutoff control for interrupting a fuel supply to the engine when controlling the lockup clutch during a deceleration of the vehicle, and (ii) is operative to interrupt the fuel cutoff control when a brake pressure of a brake device for braking the vehicle exceeds a predetermined value.

According to the present invention, in the vehicle having the engine connected to the transmission via the fluid type power transfer device having the lockup clutch, the control device performs the fuel cutoff control for interrupting the fuel supply to the engine when controlling the lockup clutch during a deceleration of the vehicle. That is, the control device operates to interrupt the fuel cutoff control when the brake pressure of the brake device for braking the vehicle exceeds the predetermined value.

Thus, by using the braking pressure excellent in response for the determining reference or standard, the sudden deceleration of the vehicle can be suppressed in a practical mode, so that with realizing the improved fuel consumption the engine stall can be appropriately suppressed. That is, the present invention can provide the control device of vehicle which can appropriately determine the sudden deceleration of vehicle to improve the fuel consumption by the fuel control upon lockup control during deceleration.

Preferably, the fuel cutoff control is interrupted when a varying rate of a wheel velocity exceeds a predetermined value. With such structure, using the varying rate of the wheel as the determining reference or standard in combination with the brake pressure can contribute to determine the sudden deceleration of the vehicle more appropriately.

Preferably, the fuel cutoff control is interrupted during the deceleration of the vehicle when the varying rate of the wheel velocity exceeds the predetermined value. With such structure, using the varying rate of the wheel as the determining reference or standard in combination with the brake pressure can contribute to determine the sudden deceleration of the vehicle more appropriately.

### BRIEF DESCRIPTION OF THE DRAWINGS

FIG. 1 is a skeleton view of a vehicular drive apparatus to which the present invention is appropriately applied.

FIG. 2 is a table showing the relationship between engaging states of engaging elements, incorporated in an automatic transmission mounted in the drive apparatus shown in FIG. 1, and selected gear positions.

FIG. 3 is a block diagram illustrating a control system provided in the drive apparatus of a vehicle for controlling an engine and an automatic transmission.

FIG. 4 is a view exemplarily showing a shift pattern of a shift lever for switching a gear position of the automatic transmission of the drive apparatus shown in FIG. 1.

FIG. 5 is a functional block diagram illustrating a control function to be executed upon signal processing in an electronic control device shown in FIG. 3.

FIG. 6 is a view showing the relationship between an accelerator-displacement value and a throttle valve opening to be used in the electronic control device shown in FIG. 3 for performing an output control of the engine.

FIG. 7 is a view showing a vehicle speed, the throttle valve opening and gear positions determined with these factors for use in a shift control of the automatic transmission for execution with the electronic control device shown in FIG. 3.

FIG. 8 is a timing chart illustrating a fuel cutoff control to be executed with the electronic control device shown in FIG. 3.

FIG. 9 is a flowchart illustrating a major part of an on-deceleration lockup control (fuel cutoff control) to be executed with the electronic control device shown in FIG. 3.

### BEST MODE FOR CARRYING OUT THE INVENTION

### Embodiment

In the following, a preferred embodiment of the present invention will be explained with reference to attached drawings.

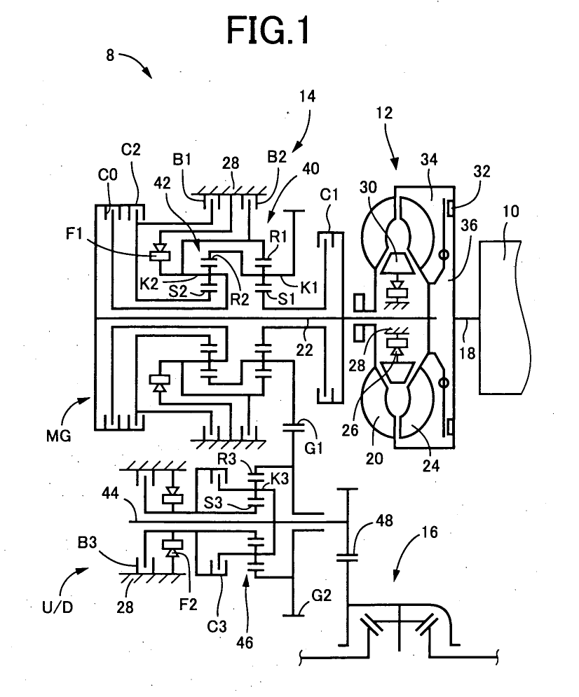

FIG. 1 is a schematic view illustrating a vehicular drive apparatus 8 to which the present invention is suitably applied. This drive apparatus 8 is suitably used for a FF vehicle (front-engine front-drive vehicle), for example. An output of an engine 10 which is a drive power source for vehicle running is transmitted to front drive wheels (not shown) of a vehicle through a power transmitting device including a torque converter 12 which is a hydraulic type power transmitting device, an automatic transmission 14 and a differential gear device 16.

The above engine 10 is an internal combustion engine such as a gasoline engine or a diesel engine which outputs power by burning a predetermined fuel. The torque converter 12 includes a pump impeller 20 connected to a crankshaft 18 of the engine 10, a turbine impeller 24 connected to an input shaft 22 of the automatic transmission 14, a stator 30 fixed to a stationary member in the form of a housing 28 through a one-way clutch 26, and transmits power between the pump impeller 20 and the turbine impeller 24 via the fluid. The torque converter 12 also includes a lockup clutch 32 which is a direct clutch for directly connecting between the pump impeller 20 and the turbine impeller 24.

This lockup clutch 32 is a hydraulic type frictionally engaging device to be frictionally engaged by a pressure difference ΔP between a hydraulic pressure in an engaging side oil chamber 34 and a hydraulic pressure in a releasing side oil chamber 36. Complete engagement of the lockup clutch 32 rotates the pump impeller 20 and the turbine impeller 24 integrally. By feedback-controlling the pressure difference ΔP i.e. engaging torque such that the pump impeller 20 and the turbine impeller 24 rotate in a slipping state, the turbine impeller 24 is caused to follow-rotate to the pump impeller 20 by a predetermined slipping amount for example 50 rpm upon driving. On the other hand, upon a reverse input (upon being driven), the pump impeller 20 is caused to follow-rotate to the turbine impeller 24 by a predetermined slipping amount for example −50 rpm.

The automatic transmission 14 includes a single-pinion type first planetary gear device 40 and a single-pinion type second planetary gear device 42 which cooperate to constitute a planetary gear mechanism of a so-called CR-CR connection type. The first and second planetary gear sets 40, 42 are disposed coaxially with the input shaft 22 such that the carrier and ring gear of the first planetary gear set 40 are respectively connected to the ring gear and carrier of the second planetary gear set 42. The automatic transmission 14 further includes a third planetary gear set 46 disposed coaxially with a counter shaft 44 parallel to the input shaft 22, and an output gear 48 fixed to one end portion of the counter shaft 44 and meshing with a differential gear device 16.

Elements of the planetary gear sets 40, 42, 46, that is, sun gears, ring gears and carriers which rotatably support planetary gears meshing with the sun gears and ring gears are selectively connected to each other through four clutches C0, C1, C2 and C3, and selectively fixed to the stationary member in the form of the housing 28 through three brakes B1, B2 and B3. Further, the sun gears, ring gears and carriers are connected to each other or brought into engagement with the housing 28, through two one-way clutches F1, F2, depending upon the direction of rotation of those elements. Since the differential gear device 16 are symmetrically constructed with respect to its axis (vehicle axis), a lower part thereof as seen in FIG. 1 is not shown in the figure.

In the drive apparatus 8 of the present embodiment, a main shifting portion MG having four forward-drive positions and one reverse-drive position is constituted by the first and second planetary gear sets 40, 42 disposed coaxially with the input shaft 22, the clutches C0, C1, C1 and C2, the brakes B1 and B2, and the one-way clutch F1. Also, an auxiliary i.e. sub shifting portion in the form of an underdrive portion U/D is constituted by the third planetary gear set 46 disposed coaxially with the counter shaft 44, the clutch C3, the brake B3 and the one-way clutch F2. In the main shifting portion MG, the input shaft 22 is connected through the clutches C0, C1 and C2 to the carrier K2 of the second planetary gear set 42, the sun gear S1 of the first planetary gear set 40 and the sun gear S2 of the second planetary gear set 42, respectively.

The ring gear R1 of the first planetary gear set 40 and the carrier K2 of the second planetary gear set 42 are connected to each other, and the ring gear R2 of the second planetary gear set 42 and the carrier K1 of the first planetary gear set 40 are connected to each other. The sun gear S2 of the second planetary gear set 42 is fixed to the stationary member in the form of the housing 28 through the brake B1, and the ring gear R1 of the first planetary gear set 40 is fixed to the stationary member in the form of the housing 28 through the brake B2. The one-way clutch F1 is disposed between the carrier K2 of the second planetary gear set 42 and the stationary member in the form of the housing 28.

A first counter gear G1 fixed to the carrier K1 of the first planetary gear set 40 and a second counter gear G2 fixed to the ring gear R3 of the third planetary gear set 46 mesh with each other. In the underdrive portion U/D, the carrier K3 and sun gear S3 of the third planetary gear set 46 are connected to each other through the clutch C3. The brake B3 and the one-way clutch F2 are disposed in parallel with each other, between the sun gear S3 and the stationary member in the form of the housing 28.

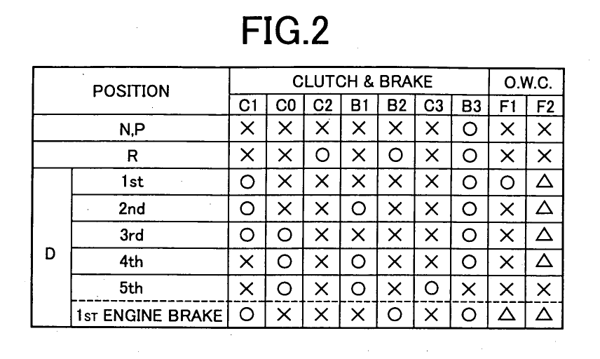

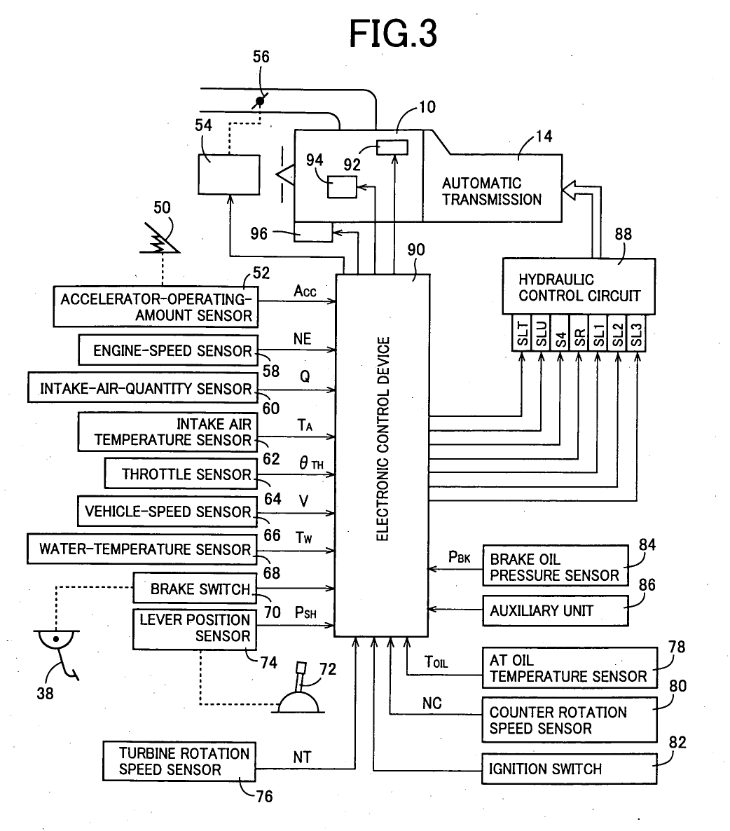

The above-described clutches C0, C1, C2 and C3 (collectively referred to as “clutches” unless distinguished otherwise) and brakes B1, B2 and B3 (collectively referred to as “brakes” unless distinguished otherwise) are hydraulically operated frictional coupling devices such as multiple-disc clutches or band brakes, which are engaged by hydraulic actuators. These frictional coupling devices are selectively engaged and released by energization and de-energization of solenoid valves S4, SR and linear solenoid valves SL1, SL2, SL3, SLT, SLU of a hydraulic control circuit 88 (shown in FIG. 3), according to an operation of a manual valve (not shown), to selectively establish five forward-drive positions, one reverse-drive position, and a neutral position of the automatic transmission 14. Selective establishment is performed as indicated in FIG. 2, according to a currently selected shift position of a shift lever 72 (shown in FIG. 3).

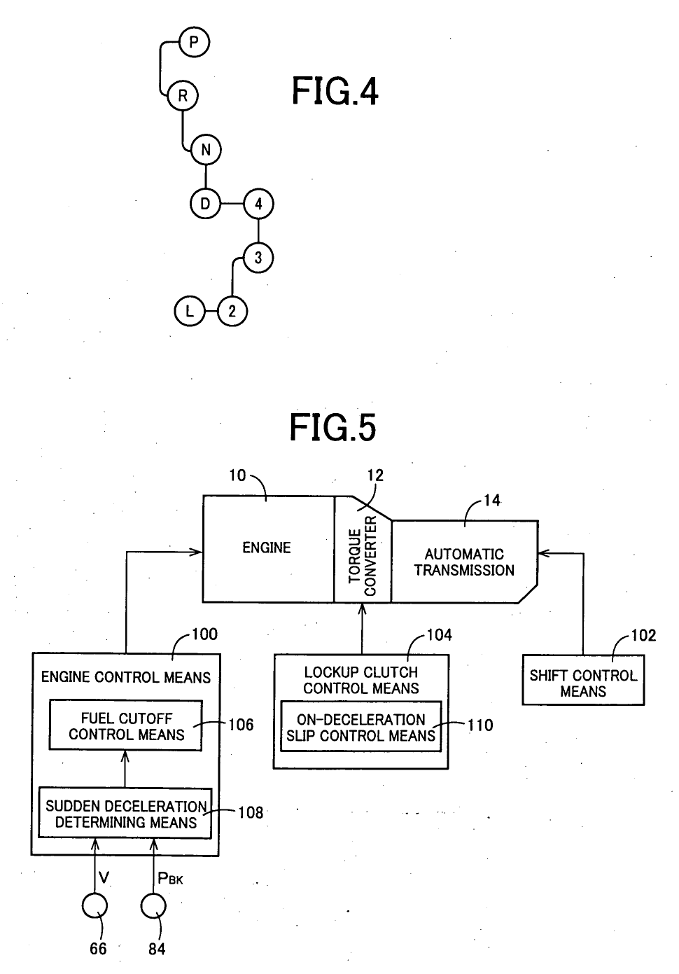

In FIG. 2, “1^{st}” through “5^{th}” represent 1^{st}-speed position through 5^{th}-speed position which are the forward-drive positions, and “O” and “X” respectively represent an engaged state and a released state of the clutch, brake or one-way clutch, while “Δ”, represents an engaged state of the one-way clutch only during driving. The shift lever 72 has a parking position “P”, a reverse-drive position “R”, a neutral position “N”, and forward-drive positions “D”, “4”, “3”, “2” and “L”, and is operable to a selected one of those positions according to a shift path shown in FIG. 4, by way of example. When the shift lever 72 is placed in the parking position P or neutral position N, the automatic transmission 14 is placed in a non-drive position in the form of the neutral position in which the vehicle drive force is not transmitted. In the parking position P, the drive wheels are mechanically locked by a mechanical parking mechanism (not shown), to prevent rotation thereof. Here, the five forward-driving-positions established by the forward-drive-position such as D, and one rear-driving-position established by rearward-drive-position R correspond to each of the driving drive positions.

FIG. 3 is a block diagram showing a control system provided on the vehicle to control the engine 10 and automatic transmission 14. In the driving apparatus 8 of the present embodiment, an operating amount (accelerator opening) A_{CC} of an accelerator pedal 50 is detected by an accelerator-operating-amount sensor 52. The accelerator pedal 50 largely operated by the operator of the vehicle by an amount corresponding to an engine output as desired by the operator, serves as a manually operated accelerating member. The accelerator-pedal operating amount A_{CC} represents the desired engine output.

In an intake pipe of the engine 10, there is disposed an electronic throttle valve 56 whose opening angle θ_{TH} is changed by a throttle actuator 54. To the electronic control device 90, signal are supplied from a engine-speed sensor 58 for detecting a rotation speed NE of the engine 10, an intake-air-quantity sensor 60 for detecting an intake air Q of the engine 10, an intake air temperature sensor 62 for detecting temperature T_{A} of an intake air, a throttle sensor 64 with an engine-idling switch for detecting a fully closed state (engine-idling state) and the opening angle θ_{TH} of the electronic throttle valve 56, a vehicle-speed sensor 66 for detecting a rotation speed (corresponding to output shaft rotation speed) N_{OUT} of the counter shaft 44 which reflects a vehicle running speed V, a water-temperature sensor 68 for detecting a temperature T_{W} of coolant of the engine 10, a brake switch 70 for detecting operated and non-operated states of a brake pedal.

There are provided a lever position sensor 74 for detecting a lever position (operated position) P_{SH} of the shift lever 72, a turbine rotation speed sensor 76 for detecting a turbine rotation speed NT (input shaft rotation speed N_{IN}), an AT oil temperature sensor 78 for detecting an AT oil temperature T_{OIL} representing a temperature of actuating oil prevailing in the torque converter 12 and a hydraulic pressure control circuit 88, a counter rotation speed sensor 80 for detecting a counter rotation speed NC of a counter gear G1, and an ignition switch 82, etc. Various signals delivered from these sensors or switches are supplied to the electronic control device 90. These signals include an engine rotation speed NE, an intake air flow quantity Q, an intake air temperature T_{A}, a throttle valve opening θ_{TH}, a vehicle speed V (output-shaft rotation speed N_{OUT}), an engine coolant temperature T_{W}, an existence or nonexistence signal related to a braking operation, etc.

In addition, the electronic control device 90 is further supplied with the shift lever position P_{SH} of the shift lever 72, the turbine rotation speed NT, the AT oil temperature T_{OIL}, the counter rotation speed NC, an operated position of the ignition switch 82, and a brake oil pressure P_{BK} delivered from a brake oil pressure sensor 84 for detecting the brake oil pressure P_{BK} such as a brake master cylinder pressure associated with the foot brake 38. The electronic control device 90 is arranged to additionally receive another signal representing the existence or nonexistence of operation initiated in an auxiliary unit 86 like an air conditioner or the other signal representing an operating state (loaded state) of such a unit. In addition, the vehicle speed V, detected by the vehicle speed sensor 66, corresponds to a speed or velocity of a vehicle wheel (not shown).

The electronic control device 90 includes a so-called microcomputer comprised of a CPU, a RAM, a ROM and input and output interfaces, etc. The CPU executes signal processing in accordance with programs preliminarily stored in the ROM while utilizing a temporarily storing function of the RAM. This allows the executions of an output control of the engine 10, a shifting control of the automatic transmission 14, and a control (slip control) of an engagement state of the lockup clutch 32. Thus, the electronic control device 90 is formed in structures to perform an engine control and a shifting control depending on needs.

FIG. 5 is a functional block diagram illustrating a control function to be executed with the electronic control device 90 upon performing signal processing. As shown in FIG. 5, the electronic control device 90 functionally includes engine control means 100, shift control means 102 and lockup clutch control means 104. Hereunder, these control functions will be described below in detail.

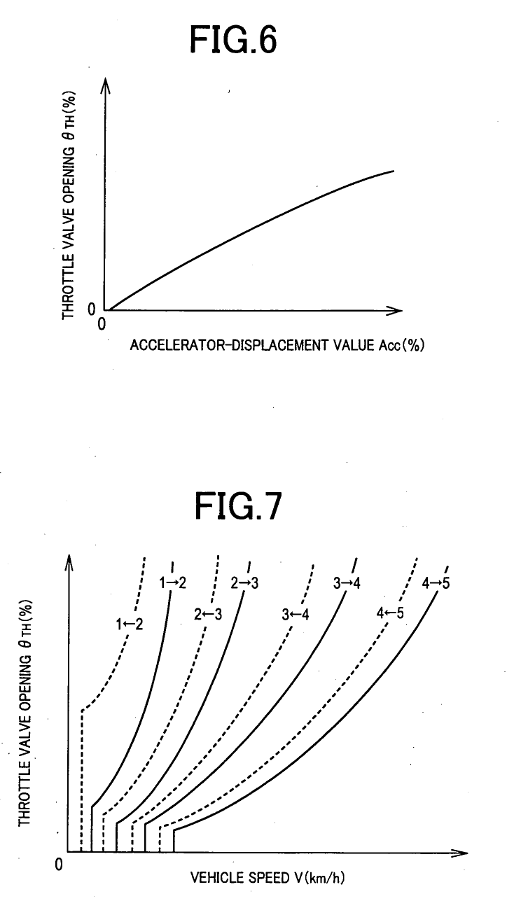

The engine control means 100 fundamentally executes the output control of the engine 10. More particularly, the throttle actuator 54 controllably opens or closes an electronic throttle valve 56. Further, the engine control means 100 controls a fuel injection device 92 for fuel injection quantity control. Moreover, the engine control means 100 controls an ignition device 94 such as an igniter for achieving an ignition timing control. In controlling the electronic throttle valve 56, the throttle actuator 54 is driven depending on an actual accelerator pedal displacement value A_{CC} by referring to the relationship shown, for instance, in FIG. 6 such that the greater the accelerator pedal displacement value A_{CC}, the greater will be the throttle valve opening θ_{TH}. Further, during a startup of the engine 10, a starter (electric motor) 96 controls the cranking of a crankshaft 18 of the engine 10.

Further, the engine control means 100 includes fuel cutoff control means 106 which performs a fuel cutoff control for interrupting the supply of fuel to the engine 10. Such control minimizes fuel consumption during a coast decelerating mode with no need for supply of fuel, resulting in improved fuel consumption.

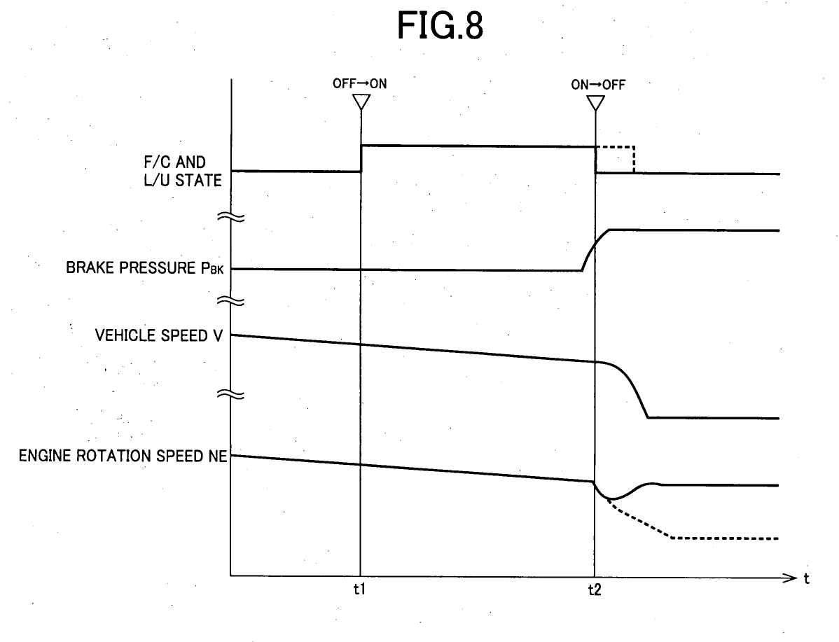

The fuel cutoff control is fundamentally performed under a condition where, for instance, the engine rotation speed NE exceeds a given fuel-cutoff return rotation speed NEFC. If the engine rotation speed NE becomes lower than the given fuel-cutoff return rotation speed NEFC, the fuel supply to the engine 10 is restarted again, thereby operating the engine 10. Further, such a fuel cutoff control is interrupted when a determination is made in a manner as described below with reference to FIG. 8. More preferably, the deceleration slip control of the lockup clutch 32 is interrupted synchronous with the interruption of the fuel cutoff control at about the same time. The deceleration slip control will be described below.

The shift control means 102 performs the shift control depending on the lever position P_{SH} of the shift lever 72 such that, for instance for a “D” position, a “D” range is established to allow the shift control to be executed in a whole of forward drive gear positions from 1st- to 5th-speed gear positions. In the “D” range, the shift control means 102 determines a gear position to be shifted in the automatic shifting portion 14 based on the actual throttle valve opening θ_{TH} and the vehicle speed V by referring to a preliminarily stored shifting diagram (shifting map) as shown for instance in FIG. 7. Then, the shift control means 102 executes a shifting output to commence a shifting action to establish a determined gear position. Meanwhile, solenoid valves S4 and SR of the hydraulic control circuit 88 are controllably turned on (energized) or turned off (de-energized) and conducting rates of electric power, supplied to linear solenoid valves SL1 to SL3 and SLU, are continuously varied. This avoids the occurrence of a shifting shock, caused by fluctuation in drive force, etc., or a damage to durability of friction materials.

In FIG. 7, solid lines represent upshift lines and broken lines represent downshift lines. With a decrease in the vehicle speed V or an increase in the throttle valve opening θ_{TH}, a gearshift occurs to a gear position at a low speed with an increasing speed ratio (a ratio of input-shaft rotation speed N_{IN} to output-shaft rotation speed N_{OUT}). In FIG. 7, references to “1” to “5” refer to selected gear positions covering a 1st-speed gear position “1st” to a 5th-speed gear position “5th”, respectively. Further, when the shift lever 72 is shifted in the lever positions “4”, “3”, “2” and “L”, the shift ranges “4”, “3”, “2” and “L” are established with differences in maximal speed gear ratios, i.e. speed ratio ranges on high speeds having decreasing speed ratios.

The shift control means 102 performs operations to establish various gear positions in various shift ranges including a “4” range under which a shifting control is executed in one of the 1st-speed gear position “1st” to the 4th-speed gear position “4th”, a “3” range under which a shifting control is executed in one of the 1st-speed gear position “1st” to the 3rd-speed gear position “3rd”, a “2” range under which a shifting control is executed in one of the 1st-speed gear position “1st” and the 2nd-speed gear position “2nd”, and an “L” range under which the gear position is fixed to the 1st-speed gear position “1st”.

The lockup clutch control means 104 basically controls an engaging state of the lockup clutch 32 incorporated in the torque converter 14. More particularly, the lockup clutch control means 104 engages (in complete engagement) or disengages the lockup clutch 32 in accordance with a lockup diagram that is preliminarily stored in terms of parameters including the throttle valve opening θ_{TH} and the vehicle speed V in the same manner as the shifting diagram set forth above.

The lockup clutch control means 104 includes on-deceleration slip control means 110. The on-deceleration slip control means 110 performs a feedback control on a duty ratio D_{SLU} of an excitation current flowing through the linear solenoid valve SLU related to the differential pressure ΔP. This feedback control is executed during a coast decelerating state in a forward drive running mode during a coast running of a vehicle with the throttle valve opening θ_{TH} remaining under a nearly zeroed state such that the lockup clutch 32 is caused to engage under a slipping state, with a given target slip rate SLP (in the order of approximately, for instance, −50 rpm).

With the lockup clutch 32 caused to engage under such a slipping state, a reverse input delivered from the drive wheels is transferred to the engine. This increases the engine rotation speed NE to a value close proximity to the turbine rotation speed NT. This expands a fuel cutoff region (in terms of a vehicle speed range) to be effectuated with the fuel cutoff control means 106, with accompanying further improved fuel consumption. Basically, when the engine rotation speed NE reaches a value close proximity to the fuel cutoff return rotation speed NEFC or when a vehicle sudden-stop determination is made, the on-deceleration slip control is interrupted with accompanying disengagement of the lockup clutch 32 for avoiding the occurrence of engine stall.

Here, if a sudden braking is effectuated during the slip control executed on the lockup clutch 32, the vehicle speed V decreases with a drop in engine rotation speed NE, resulting in likelihood of easily causing engine stall to occur. To avoid such an issue, the engine control means 100 includes sudden deceleration determining means 108 for determining the occurrence of a sudden deceleration of the vehicle based on which a determination is made whether to cause the fuel cutoff control means 106 to stop the fuel cutoff control. If the sudden deceleration determining means 108 determines the sudden deceleration occurred on the vehicle, then the fuel cutoff control means 106, not depending on the engine rotation speed NE at that point in time, interrupts the fuel cutoff control. During such operation, the engine control means 100 allows the fuel injection device 92 to restart the supply of fuel to the engine 10.

The sudden deceleration determining means 108 basically executes the operation based on a varying rate of the vehicle speed V detected with the vehicle speed sensor 66 to determine whether the sudden deceleration occurs on the vehicle. For instance, if the varying rate (deceleration rate) of the vehicle speed V exceeds a predetermined value, the sudden deceleration determining means 108 determines that the vehicle encounters the sudden deceleration. The vehicle speed V detected with the vehicle speed sensor 66 represents a value associated with a velocity of a wheel (not shown), i.e. a wheel velocity. In other words, the sudden deceleration determining means 108 executes the operation depending on the varying rate of the wheel velocity to determine whether the vehicle encounters the sudden deceleration.

Further, the sudden deceleration determining means 108 determines the occurrence of the sudden deceleration of the vehicle based on a brake pressure of the foot brake 38 serving as a braking device. For instance, the sudden deceleration determining means 108 determines that the sudden deceleration occurs on the vehicle when the brake pressure P_{BK}, detected with the braking pressure sensor 48, exceeds a predetermined value. In addition, no need necessarily arises for the brake pressure P_{BK} per se to be treated as a reference based on which the determination is made. For, instance, a brake pedal stroke, an ECB (Electronic Control Brake) command value and a brake wheel pressure, etc., may be detected and resultant detected values may be used for determining the sudden deceleration of the vehicle.

FIG. 8 is a timing chart for illustrating how the fuel cutoff control means 106 executes the fuel cutoff control. As shown in FIG. 8, at time t1, an accelerator pedal is released with a coast deceleration commenced in the forward driving mode of the vehicle, thereby establishing a start condition for the on-deceleration slip control to be executed. At this moment, the on-deceleration slip control is commenced performing the feedback control on the duty ratio D_{SLU} of the excitation current flowing through the linear solenoid valve SLU, related to the differential pressure ΔP, such that the lockup clutch 32 is engaged in slipping state with the target slipping rate SLP. In addition, the fuel cutoff control is executed to interrupt the supply of fuel to the engine 10. Next, if the sudden deceleration of the vehicle is determined at time t2, both the on-deceleration slip control and the fuel cutoff control are interrupted. This causes the lockup clutch 32 to disengage, while causing the fuel injection device 92 to begin the supply of fuel to the engine 10.

Here, variations in respective values associated with the determination on the sudden deceleration, made in the related art, i.e. the determination depending on only the wheel velocity are indicated by broken lines in FIG. 8. With such a method of determining the sudden deceleration of the vehicle based on the wheel velocity (vehicle speed V), the determination is less response than that of the determination made depending on the brake pressure P_{BK} of the brake device, with an accompanying delay in determination. This results in a delay in the beginning of supplying fuel to the engine 10, causing engine stall to occur.

On the contrary, with the method of making the determination based on the brake pressure P_{BK} of the brake device as contemplated in the present embodiment, the sudden deceleration of the vehicle can be determined based on the brake pressure P_{BK} of the brake device as quickly as possible with increased response. This appropriately enables the suppression of engine stall.

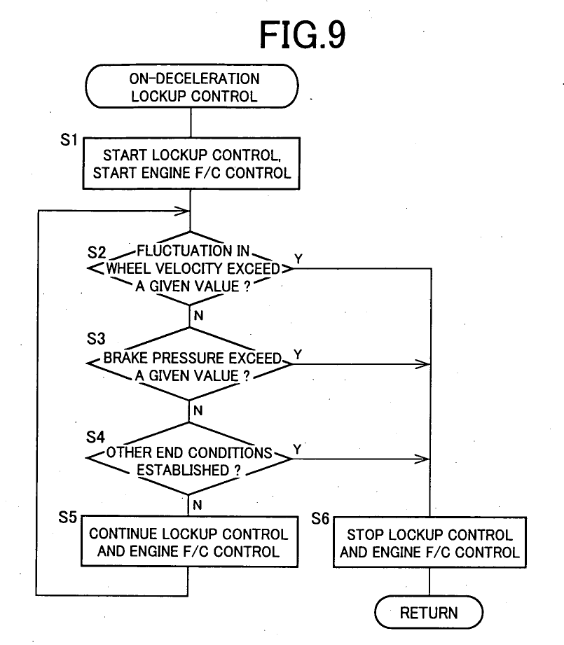

FIG. 9 is a flowchart illustrating an essential part of the on-deceleration lockup control (in the form of fuel cutoff control) that is repeatedly executed with the electronic control device 90 on given cycles.

First at step (hereinafter, the term “step” will be omitted) S1, the accelerator pedal is released with accompanying beginning of coast deceleration of the vehicle in the forward drive mode, thereby establishing a start condition of initiating the on-deceleration slip control. In this moment, the on-deceleration slip control is executed to perform the feedback control on the duty ratio D_{SLU} of the excitation current flowing through the linear solenoid valve SLU, related to the differential pressure ΔP, such that the lockup clutch 32 is engaged under the slipping state with the target slipping rate SLP. In addition, the fuel cutoff control is executed to interrupt the supply of fuel to the engine 10.

Next, at S2, a query is made as to whether fluctuation (varying rate) in the vehicle speed V (wheel velocity), detected with the vehicle speed sensor 66, exceeds a given value.

If the answer is YES, then at S6, the current routine is terminated after the on-deceleration slip control and the fuel cutoff control are interrupted. If the answer to S2 is NO, then at S3, a query is made as to whether the brake pressure P_{BK} detected with the braking pressure sensor 48 exceeds a given value. If the answer to S3 is YES, then operations subsequent to S6 are executed. If the answer to S3 is NO, then at S4, a query is made as to whether the other end conditions are established, i.e. whether the engine rotation speed NE reaches a given return rotation speed.

If the answer to S4 is YES, the operations subsequent to S6 are executed. If the answer to S4 is NO, then the operation is executed at S5 to continue the on-deceleration slip control and the fuel cutoff control with operational steps subsequent to S2 being executed again.

Among the controls mentioned above, S1, S5 and S6 collectively correspond to the operations of the fuel cutoff control means 106, and the on-deceleration slip control means 110 and S2 and S3 collectively correspond to the operation of the sudden deceleration determining means 108.

With the present embodiment, thus, when controlling the lockup clutch 32 during the deceleration of the vehicle, the control device for the vehicle executes the fuel cutoff control for the engine 10 connected to the automatic transmission 14 via the torque converter 12 having the lockup clutch 32. This interrupts the supply of fuel to the engine 10. That is, when the brake pressure P_{BK} of the foot brake 38 acting as the brake device for applying a braking effect on the vehicle exceeds the predetermined value, the fuel cutoff control needs to be interrupted. Thus, by using the brake pressure P_{BK} having increased response as a determining standard, the sudden deceleration of the vehicle can be appropriately determined in a practical mode.

Thus, it becomes possible to appropriately suppress the occurrence of engine stall while realizing improved fuel consumption. That is, the control device for vehicle which can appropriately determines the sudden deceleration of the vehicle to improve the fuel consumption by the fuel cut control upon the lockup control during deceleration.

Further, the fuel cutoff control needs to be interrupted when the varying rate of the vehicle speed V corresponding to the varying rate of the wheel velocity exceeds the predetermined value. Therefore, using the varying rate of the wheel velocity as the determining standard in combination with the brake pressure P_{BK} enables the sudden deceleration of the vehicle to be further appropriately determined.

Furthermore, the slipping engagement control of the lockup clutch 32 needs to be interrupted when the vehicle speed V, corresponding to the varying rate of the wheel velocity, exceeds the predetermined value. Therefore, using the varying rate of the wheel velocity as the determining standard in combination with the brake pressure P_{BK} enables the sudden deceleration of the vehicle to be further appropriately determined.

### <Modified Forms>

In the foregoing, although the present invention has been described above with reference to the preferred embodiment shown in the drawings, the present invention is construed not to be limited to such an embodiment but may be implemented in other modes.

For instance, the embodiment has been described above with reference to the vehicle comprised of the running drive-force source composed of only the engine 10 generating a drive power upon achieving the combustion of fuel and air. However, the present invention is construed not to be limited to such a structure and may be appropriately applied to, for instance, a hybrid vehicle propelled by another drive force source including the engine to generate the drive power upon combustion of fuel and air and, in addition thereto, an electric motor.

With the embodiment set forth above, further, while the present invention has been described above as applied to the vehicle including the automatic transmission 14 of the planetary gear type, it doesn't matter if the present invention is applied to a vehicle including au automatic transmission of another type such as a continuously variable transmission of a belt type and a transmission of a fully automatic manual type. In addition, the present invention may be applied to a vehicle including a forward- and rearward-drive switching automatic transmission operative to perform a switchover between a forward drive mode and a rearward drive mode.

Further, while the present invention has been described above as applied to the vehicle including the torque converter 12 as the fluid type power transfer device to have the torque amplifying action, the vehicle may be arranged to adopt a fluid type power transfer device of other type such as a fluid coupling or the like.

Furthermore, while the present invention has been described above with reference to the embodiment wherein the lockup clutch 32 incorporated in the torque converter 12 is of a hydraulic type friction engaging device, it may be possible to employ other various modes like those in which a friction engaging device of an electromotive type is disposed in parallel to the fluid type power transfer device.

While the embodiment of the present invention has been described above as applied to the vehicle incorporating the automatic transmission 14, i.e. the automatic transmission operative to establish a given gear position among the predetermined plural gear positions depending on the vehicle speed V or the like, the present invention is construed not to be limited to such a vehicle. That is, the vehicle may incorporate a manually operated transmission, i.e. a manual transmission. Even in this case, if a brake pressure of a brake device for braking the vehicle exceeds a predetermined value, then, interrupting the fuel cutoff control results in the same advantageous effects as those obtained by the present embodiment discussed above.

Besides, although no illustrative description will be made on every little thing, it will be appreciated that the present invention can be implemented in various alterations without departing from a scope of the present invention.

1. A control device for a vehicle having a engine connected to a transmission via fluid type power transfer device having a lockup clutch, wherein the control device (i) performs a fuel cutoff control for interrupting a fuel supply to the engine when controlling the lockup clutch during a deceleration of the vehicle, an (ii) is operative to interrupt the fuel cutoff control when a brake pressure of a brake device for braking the vehicle exceeds a predetermined value.

2. The control device for the vehicle according to claim 1, wherein the fuel cutoff control is interrupted when a varying rate of a wheel velocity exceeds a predetermined value.

3. The control device for the vehicle according to claim 1, wherein the fuel cutoff control is interrupted during the deceleration of the vehicle when the varying rate of the wheel velocity exceeds the predetermined value.

4. The control device for vehicle according to claim 1, wherein the control device includes engine control means executing an output control of the engine, shift control means executing a shift control of the shifting portion, and lockup clutch control means controlling an engaged stage of the lockup clutch.

5. The control device for vehicle according to claim 1, wherein the engine control further has fuel cutoff control means performing a fuel cutoff control for interrupting a fuel supply to the engine, during a coast decelerating mode in a forward drive.

6. The control device for a vehicle according to claim 5, wherein the fuel cutoff control is performed when the engine rotation speed exceeds a predetermined fuel-cutoff return rotation speed.

7. The control device for vehicle according to claim 4, the lockup clutch control means causes the lockup clutch to engage, release and slipping engage based on a throttle valve opening and a vehicle speed.

8. The control device for vehicle according to claim 7, the lockup clutch control means further has a on-deceleration slip control means causing the lockup clutch to slipping engage, during a coast deceleration mode in the forward drive.

9. The control device for vehicle according to claim 8, the engine control means further has a sudden deceleration determining means performing means performing a sudden deceleration of the vehicle which forms a determining standard for stopping the fuel cutoff control.

10. The control device for vehicle according to claim 9, wherein the sudden deceleration determination is performed based on a varying rate of the vehicle speed resulted from a vehicle braking regardless of the rotation speed of the engine.

11. The control device for the vehicle according to claim 2, wherein the fuel cutoff control is interrupted during the deceleration of the vehicle when the varying rate of the wheel velocity exceeds the predetermined value.
